(19) United States
(12) Patent Application Publication
(10) Pub. No.: US 2010/0023556 A1
(43) Pub. Date: Jan. 28, 2010

(54) MEDICAL IMAGE MANAGEMENT APPARATUS

(76) Inventors: Fuminori Sawada, Otawara-shi (JP); Takashi Masuzawa, Otawara-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/505,009

(22) Filed: Jul. 17, 2009

(30) Foreign Application Priority Data
Jul. 24, 2008 (JP) 2008-190968

(51) Int. Cl. G06F 17/00

(52) U.S. Cl. 707/104.1; 707/E17.009

(57) ABSTRACT

An image file reception unit receives order information data files concerning studies. An order information reception unit receives records concerning the studies, the records including medical images and supplementary information data files associated with the medical images. A discrimination unit compares items of a specific order information data file of the received order information data files and the supplementary information data files. And the discrimination unit discriminates a specific record from the received records. The specific record is in which medical images concerning not less than two studies of the studies and supplementary information data files are mixed.

### CROSS-REFERENCE TO RELATED APPLICATIONS

This application is based upon and claims the benefit of priority from prior Japanese Patent Application No. 2008-190968, filed Jul. 24, 2008, the entire contents of which are incorporated herein by reference.

### BACKGROUND OF THE INVENTION

1. Field of the Invention

The present invention relates to a medical image management apparatus for verifying a medical image and supplementary information associated with the medical image.

2. Description of the Related Art

Before a medical image is distributed to and registered in a medical image archiving apparatus, a medical image management apparatus checks whether this image has any problems, and corrects them if they are found. A technique concerning such a medical image management apparatus is disclosed in, for example, Jpn. Pat. Appln. KOKAI Publication No. 2006-94957.

At the time of imaging of medical images concerning a given patient (to be referred to as a first patient), the medical imaging apparatus may not properly perform patient switching processing due to an unforeseen situation. In this case, the medical images of the first patient are mixed in the study data (medical images and their supplementary information) of a different patient (to be referred to as a second patient). As a result, the medical images concerning the first patient are managed as medical images concerning the second patient. Consequently, the medical images concerning the first patient will be missing. If the mixing of the medical images is found, it is necessary to manually check the study data generated on the day. It takes much labor and time to solve this problem. With the recent increase in the size of hospital systems, the damage of this operation has been becoming overwhelming.

### BRIEF SUMMARY OF THE INVENTION

It is an object of the present invention to provide a medical image management apparatus which can easily find a missing medical image when the fact that medical images have become mixed up is found.

According to a first aspect of the present invention, a medical image management apparatus includes: a first reception unit which receives order information data files concerning studies; a second reception unit which receives records concerning the studies, the records including medical images and supplementary information data files associated with the medical images; and a discrimination unit which compares items of a specific order information data file of the received order information data files and the supplementary information data files, and discriminates a specific record from the received records, the specific record being in which medical images concerning not less than two studies of the studies and supplementary information data files are mixed.

According to a second aspect of the present invention, a medical image management apparatus includes: a first reception unit which receives order information data files; a second reception unit which receives medical images and supplementary information data files associated with the medical images; and a discrimination unit which compares items of a specific order information data file of the received order information data files and the supplementary information data files, and discriminates a specific medical image corresponding to the specific order information data file and specific supplementary information data file from the received medical images and the received supplementary information data files.

According to a third aspect of the present invention, a medical image management apparatus includes: a reception unit which receives records concerning the studies, the records including medical images and supplementary information data files associated with the medical images; and a discrimination unit which compares items of the order information data files, and discriminates a specific record from the received records, the specific record being in which medical images concerning not less than two studies of the studies and supplementary information data files are mixed.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the arrangement of a hospital examination room system according to the first and second embodiments of the present invention;

FIG. 2 is a functional block diagram of a medical image management apparatus according to the first embodiment in FIG. 1;

FIG. 3 is a view for explaining the mixing of image data files according to the first embodiment;

FIG. 4 is a flowchart showing a sequence of specifying/correcting processing for a study record in which a missing image data file is mixed, which is performed by the medical image management apparatus in FIG. 3;

FIG. 5 is a flowchart showing a sequence in step SA4 in FIG. 4;

FIG. 6 is a view showing an example of a list of scores displayed in step SA5 in FIG. 4;

FIG. 7 is a functional block diagram of a medical image management apparatus according to the second embodiment in FIG. 1; and

FIG. 8 is a flowchart showing a sequence of specifying/correcting processing for a study record in which a missing image data file is mixed, which is performed by the medical image management apparatus in FIG. 7.

### DETAILED DESCRIPTION OF THE INVENTION

The first and second embodiments of the present invention will be described below with reference to the views of the accompanying drawing.

### First Embodiment

FIG. 1 is a block diagram showing the arrangement of a hospital examination room system according to the first embodiment. As shown in FIG. 1, the hospital examination room system includes a radiology information system 10, a medical imaging apparatus 12, a medical image management apparatus 14, a medical image archiving apparatus 16, a medical image observation apparatus 18, and a medical image diagnosis apparatus 20 which are connected to each other via a network such as a LAN (Local Area Network).

The radiology information system 10 generates order information data file indicating the instruction contents of a study. The radiology information system 10 also transmits order information data file to the medical imaging apparatus 12 and the medical image management apparatus 14. The order information includes patient information and study information. The patient information of the order information has information concerning a patient, e.g., a patient ID and a patient name. The study information of the order information includes at least one of items concerning a study UID, a scheduled imaging count, a scheduled imaging time, the type (modality) of medical imaging apparatus, and the number of the medical imaging apparatus.

The medical imaging apparatus 12 generates an image data file of this patient in accordance with the order information of the patient from the radiology information system 10. The image data file includes a medical image data and supplementary information data associated with the medical image data.

As is known well, supplementary information is hierarchized into patient information, study information, imaging information (series information), and image information from the uppermost layer in the order named. The patient information of supplementary information includes information concerning a patient, e.g., a patient ID and a patient name. The study information of the supplementary information has information concerning a study, e.g., a study UID, a study date and time, the type of medical imaging apparatus, the number of the medical imaging apparatus, and an imaging count. The series information of the supplementary information has information concerning a series, e.g., a series UID and a series number. The image information of the supplementary information has information concerning a medical image, e.g., an image number and an imaging time.

As is known well, one study is divided into a plurality of series depending on the imaging method, technique, and the like. In addition, in each series, at least one medical image data is generated. The above supplementary information data is generated for each medical image data and associated with it. In this case, a medical image data generated by one imaging operation and its supplementary information data are compiled into one image data file. In addition, a plurality of image data files concerning one study will be collectively referred to as a study record. That is, one study record includes a plurality of image data files having the same study UID. The medical imaging apparatus 12 transmits an image data file to the medical image management apparatus 14 in a format conforming to the DICOM (Digital Imaging and Communications in Medicine) standards. In this case, the medical imaging apparatus 12 transmits image data files one by one to the medical image management apparatus 14.

Order information and supplementary information include items concerning a common case. Items concerning a common case will be referred to as common items. Common items are, for example, the type of medical imaging apparatus, the number of the medical imaging apparatus, imaging time (a scheduled imaging time in order information) and an imaging count (a scheduled imaging count in order information).

The medical image management apparatus 14 receives order information data file from the radiology information system 10 and an image data file from the medical imaging apparatus 12. The medical image management apparatus 14 specifies a study record in which a missing image data file is mixed, based on the received order information data file and the supplementary information data file of the image data file. A study record in which a missing image data file is mixed will be referred to as a mixed record. The medical image management apparatus 14 corrects at least one image data file included in a specified mixed record by using the existing correction function. The medical image management apparatus 14 transmits, to the medical image archiving apparatus 16, the corrected image data file and the image data file which was not necessary to be corrected.

The medical image archiving apparatus 16 stores the image data file transmitted from the medical image management apparatus 14. The medical image archiving apparatus 16 collectively manages a plurality of image data files having the same study UID as one study record.

The medical image observation apparatus 18 receives an image data file from the medical image archiving apparatus 16 and displays the medical image and supplementary information included in the received image data file.

The medical image diagnosis apparatus 20 receives the image data file transmitted from the medical image management apparatus 14 and displays the medical image and supplementary information included in the received image data file. The medical image diagnosis apparatus 20 also measures a medical image and displays the measurement result for image diagnosis or the like.

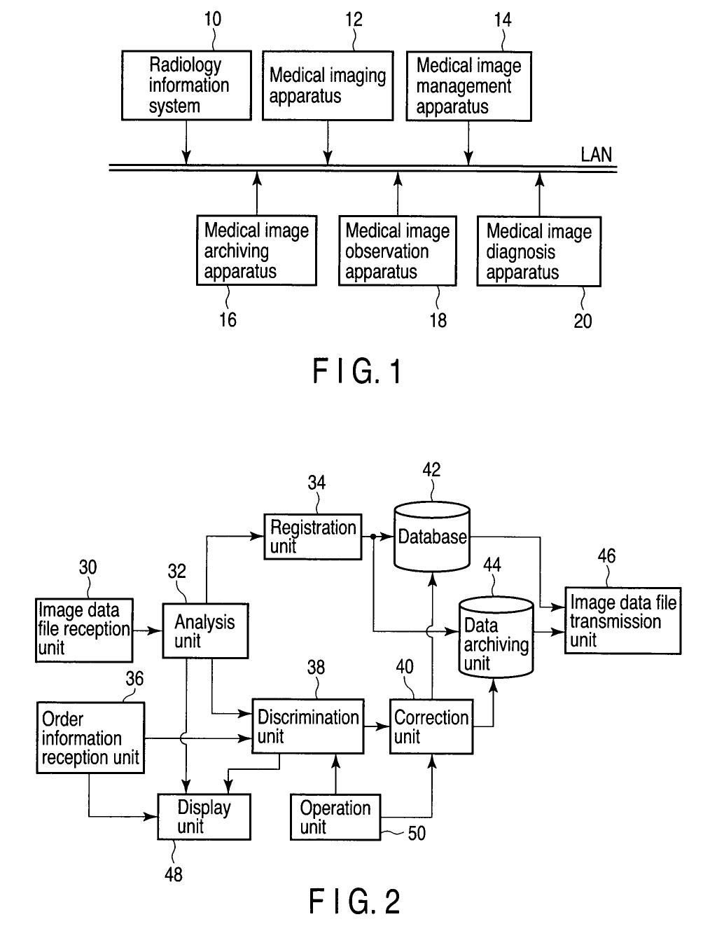

FIG. 2 is a functional block diagram of the medical image management apparatus 14. As shown in FIG. 2, the medical image management apparatus 14 includes an image data file reception unit 30, an analysis unit 32, a registration unit 34, an order information reception unit 36, a discrimination unit 38, a correction unit 40, a database 42, a data archiving unit 44, an image data file transmission unit 46, a display unit 48, and an operation unit 50.

The image data file reception unit 30 receives a plurality of image data files concerning a plurality of study records from the medical imaging apparatus 12 via a LAN. The image data file reception unit 30 transmits the received image data file to the analysis unit 32. The analysis unit 32 analyzes the supplementary information data file included in the image data file, and extracts supplementary information data file required for image management and order management from the image data file. The analysis unit 32 supplies the extracted supplementary information data file to the registration unit 34 and the discrimination unit 38. The display unit 48 displays the supplementary information data file in a predetermined layout. The registration unit 34 registers the supplementary information data file from the analysis unit 32 in the database 42 and the data archiving unit 44.

The order information reception unit 36 receives order information data file from the radiology information system 10 via a LAN. The order information is divided into patient information and study information. The received order information data file is supplied to the discrimination unit 38. The display unit 48 displays the order information in a predetermined layout.

The discrimination unit 38 compares common items of a order information data file corresponding to a missing image data file and a plurality of supplementary information data files concerning a plurality of study records. The discrimination unit 38 then discriminates a mixed record from a plurality of study records. The discriminated mixed record includes medical images data concerning two or more studies of a plurality of studies and supplementary information data files In other words, the discrimination unit 38 discriminates whether there is a study record including at least one image data file concerning another study among a plurality of study records. More specifically, the discrimination unit 38 compares, concerning the content of a common item, order information data files concerning the respective image data files, and calculates a score corresponding to the degree of similarity. The discrimination unit 38 then specifies a mixed record based on the sum of scores. In this case, the display unit 48 displays a list of the sums of scores. The discrimination unit 38 supplies the image data file included in the specified mixed record to the correction unit 40.

The correction unit 40 corrects the image data file from the discrimination unit 38 by an existing technique in accordance with an instruction issued by the user via the operation unit 50. The correction unit 40 registers the corrected image data file in the database 42 and the data archiving unit 44.

The database 42 manages information for searching a mixed record, the image data file received by the image data file reception unit 30, and the order information data file received by the order information reception unit 36. The data archiving unit 44 stores the image data file received by the image data file reception unit 30 and the order information data file received by the order information reception unit 36 in a proper location.

The image data file transmission unit 46 reads out image data files from the database 42 and the data archiving unit 44. And the image data file transmission unit 46 transmits them to the medical image archiving apparatus 16 via the LAN shown in FIG. 1.

The display unit 48 includes a display device such as a CRT (Cathode-Ray Tube). The display unit 48 displays a list of study records and a list of order information. The display unit 48 displays a list of the sums of scores added by the discrimination unit 38.

The operation unit 50 accepts various kinds of commands and information inputs from the operator. As the operation unit 50, a pointing device such as a mouse or a trackball, a selection device such as a mode switch, or an input device such as a keyboard can be used as needed.

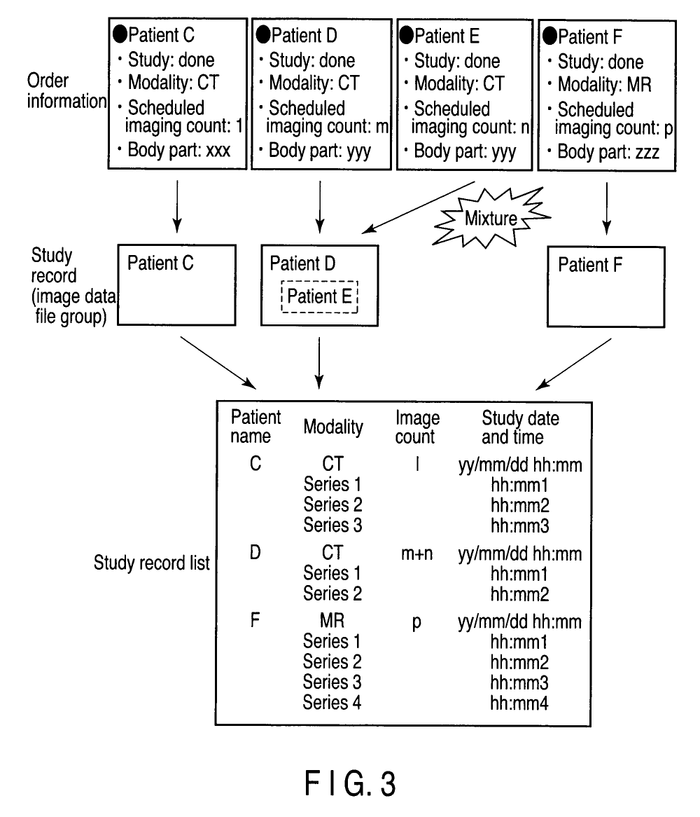

A sequence of processing in the medical image management apparatus 14 will be described in detail below. The mixing of image data files will be described first with reference to FIG. 3. Upon receiving a request for a study concerning a given patient, the radiology information system 10 generates order information. The order information includes patient information and study information. More specifically, the order information includes items such as a patient name, modality, scheduled imaging count, and body part examined. The medical imaging apparatus 12 obtains a medical image data based on this order information. In general, when a study on a given patient is complete and a study on the next patient starts, the engineer executes the patient switching function provided for the medical imaging apparatus 12 or the like. By executing this patient switching function, the medical imaging apparatus 12 recognizes that the previously obtained medical image and the medical image to be obtained next belong to different studies.

Assume that studies will be made on patients C, D, E, and F in the order named. For example, order information concerning the patient C indicates that the modality to be used to obtain medical images is “CT”, the scheduled imaging count is “1”, and the body part examined is “xxx”. When an actual study is performed, the status of study is changed from “wait” to “done”. When the study is performed, and a technician or the like executes the patient switching function, the medical imaging apparatus 12 finishes the study on the patient C.

When the study on the patient C is complete, a preparation is made for a study on the patient D. When the preparation is complete, this system performs the study on the patient D in accordance with order information concerning the patient D. When the study on the patient D is complete, the system performs a study on the patient E. Assume that when switching should have been performed from the study on the patient D to the study on the patient E, the patient switching function has not been executed or has not been normally executed due to an unforeseen situation. In this case, as shown in FIG. 3, the medical imaging apparatus 12 erroneously recognizes an image data file concerning the patient E as an image data file concerning the patient D. That is, the image file which should be included in the study record concerning the patient E is mixed in the study record concerning the patient D.

FIG. 3 shows an example of how a list of study records is displayed when such mixing of image data files has occurred. This study list indicates the patient names, modalities (the types of medical imaging apparatuses), actual imaging counts, and study dates and times (including imaging times). Note that the study dates and times are displayed for the respective series. As indicated by this list, the study information (study record) concerning the patient E is mixed in the study information (study record) concerning the patient D. Note that the display unit 48 of the medical image management apparatus 14 displays this list.

The mixing of image data files has been described above.

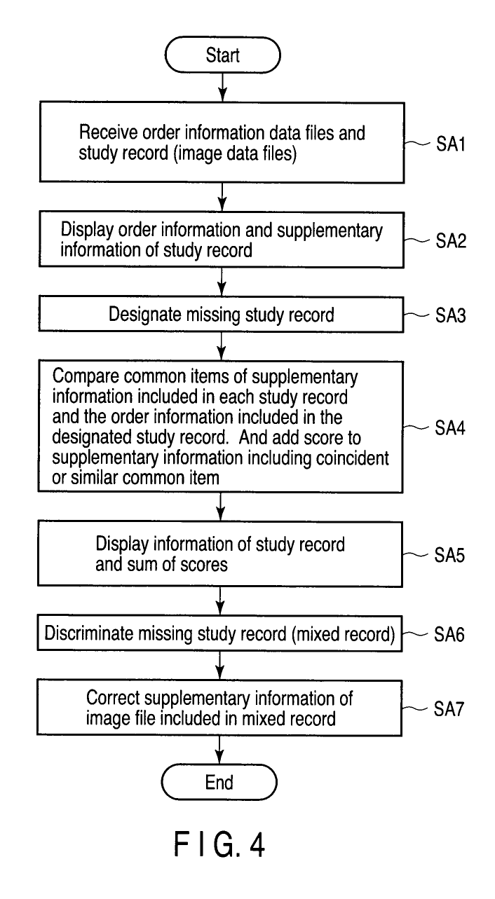

Mixed record specifying/correcting processing will be described next with reference to FIG. 4. FIG. 4 is a flowchart showing a sequence of mixed record specifying/correcting processing.

### (Step SA1)

The order information reception unit 36 receives order information data file from the radiology information system 10 via the LAN to verify whether imaging has been properly performed. If, for example, order information is necessary, the medical image management apparatus 14 issues a transmission request for order information data file to the radiology information system 10. Upon receiving the transmission request for order information, the radiology information system 10 transmits order information data file to the medical image management apparatus 14. In addition, the image file reception unit 30 receives an image data file from the medical imaging apparatus 12 via the LAN to verify whether imaging has been properly performed. When the generation of an image data file is complete, the image data file is transmitted to the medical image management apparatus 14. Upon receiving the image data file, the analysis unit 32 extracts necessary information for verification from the image data file. Necessary information includes, for example, patient information, the type of medical imaging apparatus, the number of the medical imaging apparatus, an imaging time, and an imaging count. The image data file reception unit 30 sends a plurality of image data files having the same study UID to the analysis unit 32. Upon determining that any image data file having the same study UID has not been sent for a predetermined period of time after the reception of an image data file, the analysis unit 32 collectively manages a plurality of image data files having the same study UID, which have already been received, as one study record.

### (Step SA2)

The display unit 48 displays the received order information list and study list. More specifically, the study list displayed in step SA2 is the list shown in FIG. 3.

### (Step SA3)

Order information is generated independently of a study record. Even if, therefore, information is mixed in a study record, no information is mixed in order information. The user can therefore know the existence of a missing study record (image data file) by comparing an order information list with a study list. Upon finding a missing study record, the user designates order information concerning the missing study via the operation unit 50. The user then inputs keyword information for specifying a study record in which the missing study record is mixed, i.e., a mixed record via the operation unit 50. The keyword information is information concerning at least one of the type of medical imaging apparatus, the number of the medical imaging apparatus, the imaging time, and the imaging count which are written in the order information.

### (Step SA4)

The discrimination unit 38 compares common items of supplementary information included in each study record and the designated order information included in the missing study record. And the discrimination unit 38 adds a score to a study record including a coincident or similar common item. A common item is keyword information input in step SA3. A score to be added is preferably changed in accordance with the type of common item. In addition, a score to be added may be changed in accordance with the degree of similarity. Common items include, for example, the type of medical imaging apparatus, the number of the medical imaging apparatus, an imaging time, a patient switching time, and an imaging count. A method of adding a score for each common item will be described below. It is assumed that the user inputs keyword information via the operation unit 50. However, it suffices to set items as keyword information in advance to allow the discrimination unit 38 to automatically read keyword information.

### [Type (Modality) of Medical Imaging Apparatus]

The types of medical imaging apparatuses are specifically an X-ray computed tomography apparatus (X-ray CT apparatus), magnetic resonance imaging apparatus, PET (Position Emission Tomography), SPECT (Single Photon Emission Computed Tomography), and the like. The discrimination unit 38 adds a predetermined score to a study record including a medical image obtained by the same type of medical imaging apparatus as that written in order information concerning a missing study. Assume that this predetermined score is set in advance. The discrimination unit 38 can add a score for either each medical image, each study, or each series.

### [Number of Medical Imaging Apparatus]

The number of a medical imaging apparatus is a number for uniquely specifying the medical imaging apparatus 12 equipped in the hospital. The discrimination unit 38 adds a predetermined score to a study record including a medical image obtained by a medical imaging apparatus with the same number as that of the medical imaging apparatus written in order information concerning a missing study. Assume that this predetermined score is set in advance. The discrimination unit 38 can add a score for either each medical image, each study, or each series.

### [Imaging Time]

An imaging time indicates the time when a medical image is obtained. An imaging time is added to each medical image. The discrimination unit 38 compares the scheduled imaging time written in order information concerning a missing study with the imaging time of the medical image included in an image file as a comparison target. The discrimination unit 38 then adds a score corresponding to the degree of similarity to a study record including the image file as the comparison target. Note that medical images as comparison targets for imaging times are limited to those obtained by the same type of medical imaging apparatus as that which has obtained a medical image included in the missing image file. The discrimination unit 38 adds a score of 0 to a study record including no medical image obtained by the same type of medical imaging apparatus as that which has obtained a medical image included in the missing image file.

Note that a score adding method to be used is not limited to the above method. For example, it suffices to calculate a score S by using a constant C1, scheduled imaging time Tm written in order information concerning a missing study, an imaging time Ts of a study record as a comparison target, and a constant C2 according to equation (1) given below:

S=(C1−(Tm−Ts)/C1)×C2 (1)

The imaging time Ts of the study record as the comparison target is the average value of the imaging times of a plurality of medical images included in the study record as the comparison target which are obtained by the same type of medical imaging apparatus as that which has obtained a medical image included in the missing image file. The user or the like can arbitrarily set the constants C1 and C2. The constants C1 and C2 need to be set so as to increase the score S as the scheduled imaging time Tm becomes more approximate to the imaging time Ts. Note that the discrimination unit 38 adds a score of 0 to a study record including no medical image obtained by the same type of medical imaging apparatus as that which has obtained a medical image included in a missing image file.

### [Patient Switching Time]

A patient switching time is the time interval from the end of a study on a given patient to the start of a study on the next patient. It is known that this patient switching time is generally about five min. The discrimination unit 38 calculates the time intervals between the imaging times of the respective medical images included in a study record as a comparison target. The discrimination unit 38 compares each calculated time interval with a preset patient switching time (e.g., five min). The discrimination unit 38 adds a predetermined score to the study record as the comparison target when a time interval equal to or more than the patient switching time is calculated. Note that medical images to be set as comparison targets are limited to those obtained by the same type of medical imaging apparatus as that which has obtained a medical image included in a missing image file. The discrimination unit 38 adds a score of 0 to a study record including no medical image obtained by the same type of medical imaging apparatus as that which has obtained a medical image included in a missing image file.

### [Imaging Count]

An imaging count is the number of medical images obtained in one study. The discrimination unit 38 compares the scheduled imaging count written in the order information of a missing image file with the number of images (the number of files) included in a study record as a comparison target. If the number of images included in the study record as the comparison target is larger than the scheduled imaging count written in the order information of the missing image file, the discrimination unit 38 adds a predetermined score to the study record as the comparison target. This predetermined score is set in advance. If the number of images included in the study record as the comparison target is smaller than the scheduled imaging count written in the order information, the discrimination unit 38 adds a predetermined score of 0 to the study record as the comparison target. In this case, medical images as comparison targets are limited to those obtained by the same type of medical imaging apparatus as that which has obtained a medical image included in a missing image file. The discrimination unit 38 adds a score of 0 to a study record including no medical image obtained by the same type of medical imaging apparatus as that which has obtained a medical image included in a missing image file.

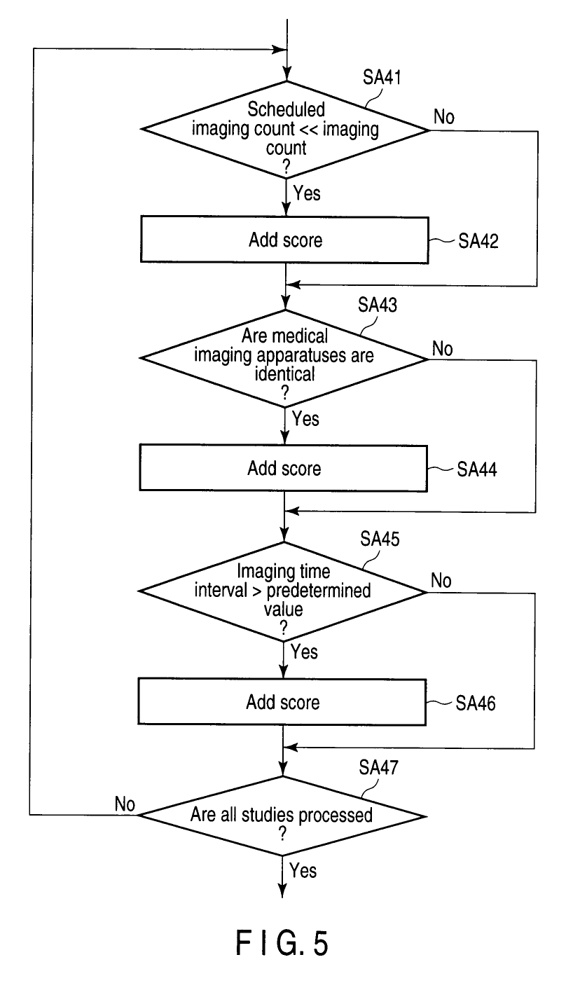

A typical sequence of operation in step SA4 executed by the discrimination unit 38 will be described below. FIG. 5 is a flowchart showing a sequence in step SA4. As shown in FIG. 5, the discrimination unit 38 compares, concerning each common item, order information concerning a missing study with a study record as a comparison target, or analyzes a patient switching time concerning the study record as the comparison target. The study record as the comparison target is, for example, a study record concerning the study date of a missing study.

First of all, the discrimination unit 38 compares the imaging count in a study record as a comparison target with the imaging count in order information concerning a missing study (step SA41). If the imaging count written in the study record as the comparison target is larger than the imaging count (scheduled imaging count) written in the order information concerning the missing study (step SA41: YES), the discrimination unit 38 adds a predetermined score to the study record as the comparison target (step SA42). If the imaging count written in the study record as the comparison target is not larger than the imaging count (scheduled imaging count) written in the order information concerning the missing study (step SA41: NO), the discrimination unit 38 adds no predetermined score (or adds a score of 0) to the study record as the comparison target.

The discrimination unit 38 then discriminates whether the medical imaging apparatus written in the study record as the comparison target coincides with the medical imaging apparatus written in the order information concerning the missing study (step SA43). If the medical imaging apparatus written in the study record as the comparison target coincides with the medical imaging apparatus written in the order information concerning the missing study (step SA43: YES), the discrimination unit 38 adds a predetermined score to the study record as the comparison target (step SA44). If the medical imaging apparatus written in the study record as the comparison target does not coincide with the medical imaging apparatus written in the order information concerning the missing study (step SA44: NO), the discrimination unit 38 adds no predetermined score (or adds a score of 0) to the study record as the comparison target.

The discrimination unit 38 then discriminates whether the intervals between the respective imaging times written in the study record as the comparison target are longer than a predetermined value (e.g., five min) (step SA45). If there is a time interval longer than the predetermined value (step SA45: YES), the discrimination unit 38 adds a predetermined score to the study record as the comparison target (step SA46). If there is no time interval longer than the predetermined value (step SA45: NO), the discrimination unit 38 adds no predetermined score (or adds a score of 0) to the study record as the comparison target.

When steps SA41 to SA46 are complete, the discrimination unit 38 changes the study record as the comparison target to another study record and repeats steps SA41 to SA46 for it. When all study records concerning the study date of the missing study are processed in this manner (step SA47), the discrimination unit 38 terminates step SA4.

### (Step SA5)

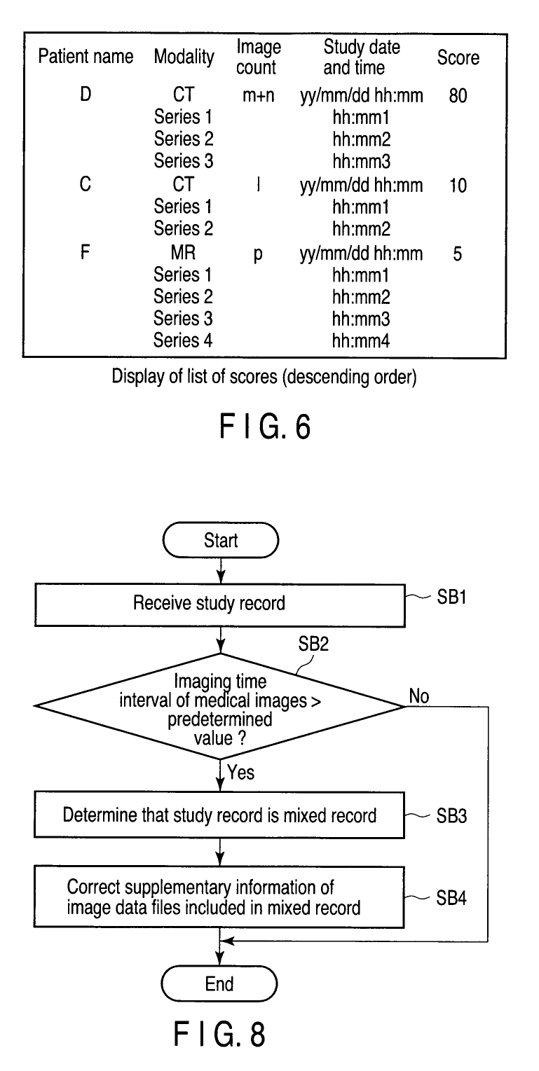

When score calculation for each study record is complete, the display unit 48 displays a list of study records in descending order of scores, as shown in FIG. 6. For example, the display unit 48 may display study records with top three scores. It is highly possible that the missing study record is mixed in the study record to which the highest score is added. To perform correction, the user operates the operation unit 50 to select, on the window, the study record to which the highest score is added.

### (Step SA6)

When the user selects a study record via the operation unit 50, the discrimination unit 38 sets the selected study record as a mixed record. The correction unit 40 then sets the selected study record as a correction target. Note that the discrimination unit 38 may automatically set the study record to which the highest score is added as a mixed record. Alternatively, the discrimination unit 38 may compare a preset threshold with a score to automatically set a study record to which a score equal to or more than the threshold is added as a mixed record.

### (Step SA7)

Upon setting a study record as a correction target, the correction unit 40 corrects the supplementary information of an image data file included in this study record. During correction processing of the study record, the display unit 48 displays a list of medical images which are included in the study record as the correction target and obtained by the same type of medical imaging apparatus as that which has obtained a medical image included in the missing image data file. In this case, the display unit 48 displays the images in the order of imaging times. In addition, if there is a time interval between imaging times which is longer than the patient switching time, the display unit 48 preferably adds a mark or the like indicating patient switching operation to the corresponding portion. The image data file transmission unit 46 transmits the corrected study record to the medical image archiving apparatus 16 via the LAN. The medical image archiving apparatus 16 then archives the study record.

More specifically, in step SA7, the correction unit 40 performs separation processing, supplementary information correction processing, and merge processing. Note that separation processing and supplementary information correction processing are always performed, but merge processing is performed as needed.

### [Separation Processing]

The missing study record is separated from the study record in which the missing study record is mixed. If a mark indicating patient switching is displayed in the list of study data, the correction unit 40 divides the study record at the mark as a boundary. For example, when the user selects one of the study records via the operation unit 50, the correction unit 40 sets the selected study record as a missing study record. The correction unit 40 then advances from separation processing to correction processing.

### [Correction Processing]

The correction unit 40 automatically corrects the supplementary information included in the missing study record after the separation processing based on order information concerning the missing study. Likewise, the correction unit 40 automatically corrects the study record in which the missing study record has been mixed, based on order information corresponding to the study record. In this case, the correction unit 40 also automatically corrects Study Instance UID defined by the DICOM standards based on the order information. The corrected study record is registered in the database 42 and the data archiving unit 44.

### [Merge Processing]

Some missing study record includes a plurality of medical images obtained by different types of medical imaging apparatuses. In this case, of the plurality of medical images, a medical image obtained by the same type of medical imaging apparatus as that written in order information concerning the missing study will be referred to as the first type of medical image, and a medical image obtained by a medical imaging apparatus of a type different from that written in the order information concerning the missing study will be referred to as the second type of medical image. Image files having the same Study Instance UID should be compiled in the same study record. Based on this principle, the correction unit 40 reads out study records having the same Study Instance UID as that the corrected study record includes in from the database 42 and the data archiving unit 44, and merges the read study records with the corrected study record.

As in the above arrangement, the medical image management apparatus 14 receives order information data file from the radiology information system 10 and receives an image data file from the medical imaging apparatus 12. The medical image management apparatus 14 discriminates a mixed record by comparing order information concerning a missing study with supplementary information of image data files concerning a plurality of studies. As described above, when it is found that a medical image is mixed, the medical image management apparatus 14 according to the first embodiment can easily find the missing medical image.

Note that in the above arrangement, the medical image management apparatus 14, the medical image archiving apparatus 16, and the radiology information system 10 are separate apparatuses. However, the first embodiment need not be limited to this. For example, the medical image archiving apparatus 16 or the radiology information system 10 can have the function of the medical image management apparatus 14.

### Second Embodiment

A medical image management apparatus 14 according to the second embodiment of the present invention will be described below. Note that the same reference numerals denote constituent elements having almost the same functions as in the first embodiment, and a repetitive description will be made only when required.

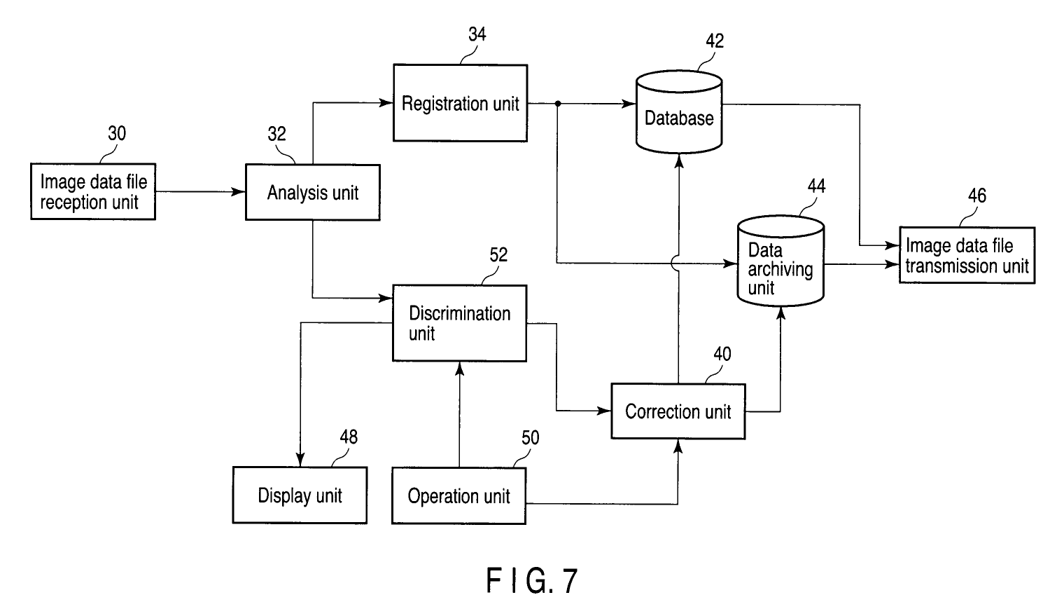

FIG. 7 is a functional block diagram of the medical image management apparatus 14 according to the second embodiment. As shown in FIG. 7, the medical image management apparatus 14 includes an image data file reception unit 30, an analysis unit 32, a registration unit 34, a correction unit 40, a database 42, a data archiving unit 44, an image data file transmission unit 46, a display unit 48, an operation unit 50, and a discrimination unit 52.

The discrimination unit 52 compares items of the supplementary information data files of a plurality of image files included in a study record. The discrimination unit 52 then discriminates whether the study record is a mixed record. The discrimination unit 52 supplies the image data files included in the discriminated mixed record to the correction unit 40.

Mixed record specifying/correcting processing according to the second embodiment will be described next with reference to FIG. 8. FIG. 8 is a flowchart showing a sequence of mixed record specifying/correcting processing.

### (Step SB1)

The image file reception unit 30 receives a study record from a medical imaging apparatus 12 or a medical image archiving apparatus 16 via a LAN to verify whether imaging has been properly performed. When the image file reception unit 30 receives a study record, the analysis unit 32 extracts information necessary for verification from each of a plurality of image data files included in the study record. The analysis unit 32 supplies the extracted information to the discrimination unit 52. The necessary information includes, for example, the type of medical imaging apparatus, the number of the medical imaging apparatus, a body part examined, and an imaging condition such as an imaging time. For a concrete description, assume that the imaging condition is an imaging time.

### (Step SB2)

The discrimination unit 52 calculates the time interval between a plurality of imaging times. The discrimination unit 52 then compares the calculated time interval with a predetermined value set in advance. The predetermined value is set to a value larger than a standard patient switching time. For example, the predetermined value is set to a value between 5 min and 10 min. If the calculated time interval is larger than the predetermined value (step SB2: YES), the discrimination unit 52 advances to step SB3. If the calculated time interval is smaller than the predetermined value (step SB2: NO), the discrimination unit 52 discriminates that the study record is not a mixed record. When the discrimination unit 52 discriminates that the study record is not a mixed record, the mixed record specifying/correcting processing is terminated.

### (Step SB3)

If the time interval is larger than the predetermined value, the discrimination unit 52 discriminates that the study record is a mixed record. The discrimination unit 52 supplies the image data files included in the discriminated mixed record to the correction unit 40.

### (Step SB4)

The correction unit 40 corrects the supplied image data files by the same method as that in the first embodiment. The image data file transmission unit 46 transmits the corrected study record to the medical image archiving apparatus 16 via the LAN. The medical image archiving apparatus 16 then archives the image data files.

As in the above arrangement, the medical image management apparatus 14 receives a study record (a plurality of image data files) from the medical imaging apparatus 12. The medical image management apparatus 14 then compares, concerning an item (typically an imaging time), the supplementary information data file of a plurality of image data files to discriminate whether the study record is a mixed record. When it is found that a medical image data is mixed, the medical image management apparatus 14 according to the second embodiment can easily find the missing medical image.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A medical image management apparatus comprising:
a first reception unit which receives order information data files concerning studies;
a second reception unit which receives records concerning the studies, the records including medical images and supplementary information data files associated with the medical images; and
a discrimination unit which compares items of a specific order information data file of the received order information data files and the supplementary information data files, and discriminates a specific record from the received records, the specific record being in which medical images concerning not less than two studies of the studies and supplementary information data files are mixed.

2. The apparatus according to claim 1, wherein the item includes at least one of a medical imaging apparatus, an imaging time, and an imaging count.

3. The apparatus according to claim 1, wherein the discrimination unit calculates a score indicating a degree of similarity between a content of the item included in the specific order information data file and a content of the item included in the supplementary information data files for each of the received records, and discriminates the specific record from the received records based on the calculated score.

4. The apparatus according to claim 3, further comprising a display unit which displays the calculated score.

5. A medical image management apparatus comprising:
a first reception unit which receives order information data files;
a second reception unit which receives medical images and supplementary information data files associated with the medical images; and
a discrimination unit which compares items of a specific order information data file of the received order information data files and the supplementary information data files, and discriminates a specific medical image corresponding to the specific order information data file and specific supplementary information data file from the received medical images and the received supplementary information data files.

6. A medical image management apparatus comprising:
a reception unit which receives records concerning the studies, the records including medical images and supplementary information data files associated with the medical images; and
a discrimination unit which compares items of the supplementary information data files, and discriminates a specific record from the received records, the specific record being in which medical images concerning not less than two studies of the studies and supplementary information data files are mixed.

7. The apparatus according to claim 6, wherein the item is an imaging time.
